(19) United States
(12) Patent Application Publication
(10) Pub. No.: US 2015/0242474 A1
(43) Pub. Date: Aug. 27, 2015

(54) INLINE AND CONTEXT AWARE QUERY BOX

(71) Applicant: Microsoft Corporation, Redmond, WA (US)

(72) Inventors: Krister Mikalsen, Tromso (NO); Knut Kristian Johansen, Tromso (NO); Dag Eidesen, Tromso (NO); Andre Soreng, Tromso (NO)

(73) Assignee: Microsoft Corporation, Redmond, WA (US)

(21) Appl. No.: 14/192,663

(22) Filed: Feb. 27, 2014

(51) Int. Cl. G06F 17/30

(52) U.S. Cl. CPC G06F 17/30554; G06F 17/30896; G06F 17/30882; G06F 17/30864

(57) ABSTRACT

A query box application provides an inline and context aware query box. An interaction with a content displayed in a client application is detected, in which the interaction is interpreted to activate a query box. The query box is configured based on a context in response to a determination of the context associated with the content. A text of a part of the content may be used to search local and external sources to find resulting data associated with the text. The query box may be rendered with the resulting data in proximity to a location associated with the interaction.

### BACKGROUND

Users rely on search to complete tasks in the connected world. Search is used extensively to research and find information within and outside an organization. A typical task pattern for a user is to use search services to research public information and search local services within an organization to conduct information gathering. As such, the user frequently switches between information gathering with one set of search tools and complete intended tasks with another set of specialized tools.

Search and task completion systems are usually separate systems. The separate systems force the user to switch between several applications to complete tasks at a cost of context switching and lack of focus. The user is forced to keep a number of application panes in focus while conducting a search during task completion. The user usually has browser panes, email panes, document processing panes, presentation application panes open concurrently. The user is usually forced to copy and paste information between the panes to compose a new document.

Modern devices like tablets and mobile phones are often constrained by an inability to have multiple applications open concurrently. As such, context switching in modern environments is less likely to be an efficient solution to task completion associated with searches.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to providing an inline and a context aware query box. A query box application may detect an interaction with content displayed in a client application, in which the interaction is interpreted to activate a query box. A context associated with the content may be determined. Next, the query box may be configured based on the context. The query box may be rendered in proximity a location associated with the interaction. Alternatively, the query box may be displayed as a component of the client application. The query box may be globally/universally available through any client application.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating an inline and a context aware query box, according to embodiments;

FIG. 2 is an example user interface illustrating an inline and a context aware query box within a note application, according to embodiments;

FIG. 3 is another example user interface illustrating an inline and a context aware query box within an email application, according to embodiments;

FIG. 4 is another example user interface illustrating an inline and a context aware query box within a communication application;

FIG. 5 is another example user interface illustrating an inline and a context aware query box as a component of a client application;

FIG. 6 is a simplified networked environment, where a system according to embodiments may be implemented;

FIG. 7 is a block diagram of an example computing operating environment, where embodiments may be implemented; and

FIG. 8 illustrates a logic flow diagram for a process to provide an inline and a context aware query box according to embodiments.

### DETAILED DESCRIPTION

As briefly described above, an inline and a context aware query box may be provided. A query box application may detect a interaction from a client application, in which the interaction is interpreted to activate a query box. The query box may be configured based on a context in response to determining the context associated with the content. The query box may be rendered in proximity to a location associated with the interaction.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, and a flash drive.

Throughout this specification, the term “platform” may be a combination of software and hardware components to provide an inline and a context aware query box. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example embodiments may be found in the following description.

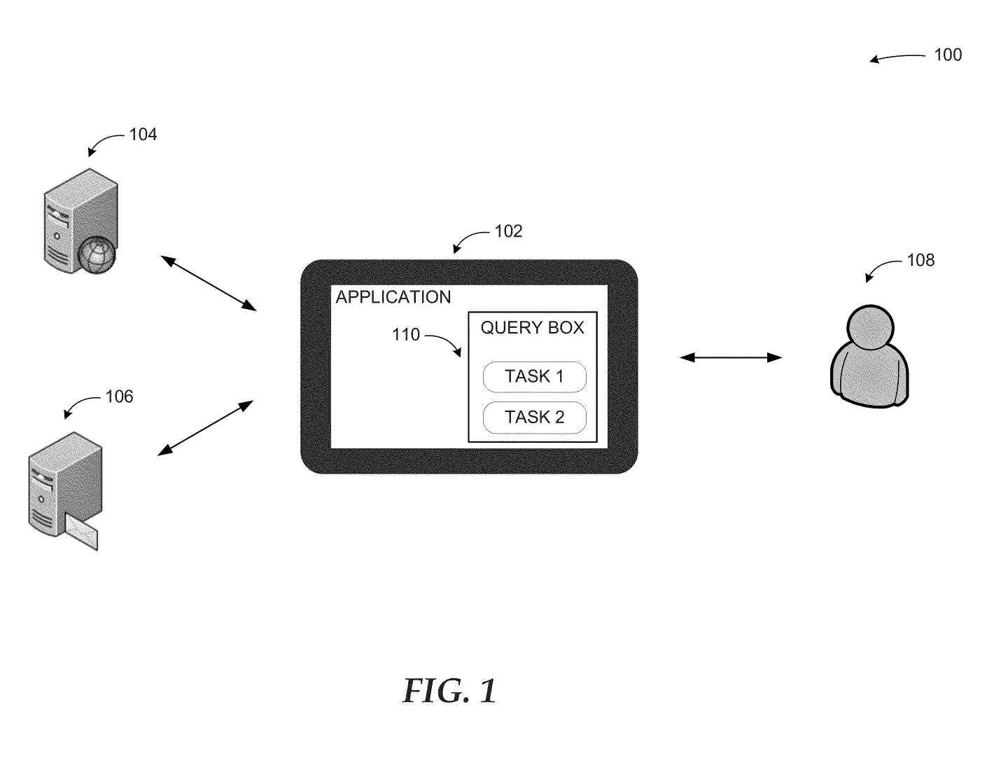

FIG. 1 includes a conceptual diagram 100 illustrating an inline and a context aware query box, according to embodiments.

A client device 102 may execute an application rendering content. The content may be stored locally or retrieved from external sources such as a content server 104 and a communication server 106. The content may be presented by the client application to a user 108. Although a tablet computer is provided as an example of the client device 102, the client device 102 is not limited to a tablet computer. The client device 102 may include a smart phone, a desktop computer, a notebook computer, and similar ones.

A query box application executing separately from the client application may detect an interaction initiated by the user 108. The interaction may include one or more keyboard strokes and a selection of the content. The query box 110 may be configured based on a context associated with the content. The query box 110 may be rendered in proximity to a location associated with the interaction.

According to some embodiments, the query box application may be rendered as a component of the client application. The query box may be global/universal, and also made available through any client application.

While the example system in FIG. 1 has been described with specific components including the client device 102 displaying an inline and a context aware query box, embodiments are not limited to these components or system configurations and can be implemented with other system configuration employing fewer or additional components. In an alternate example, the query box application may execute in an external server. The query box application may be provided as a service to the client device 102. The approaches discussed here may be applied to any compliance process provided by an application and/or a server using the principles described herein.

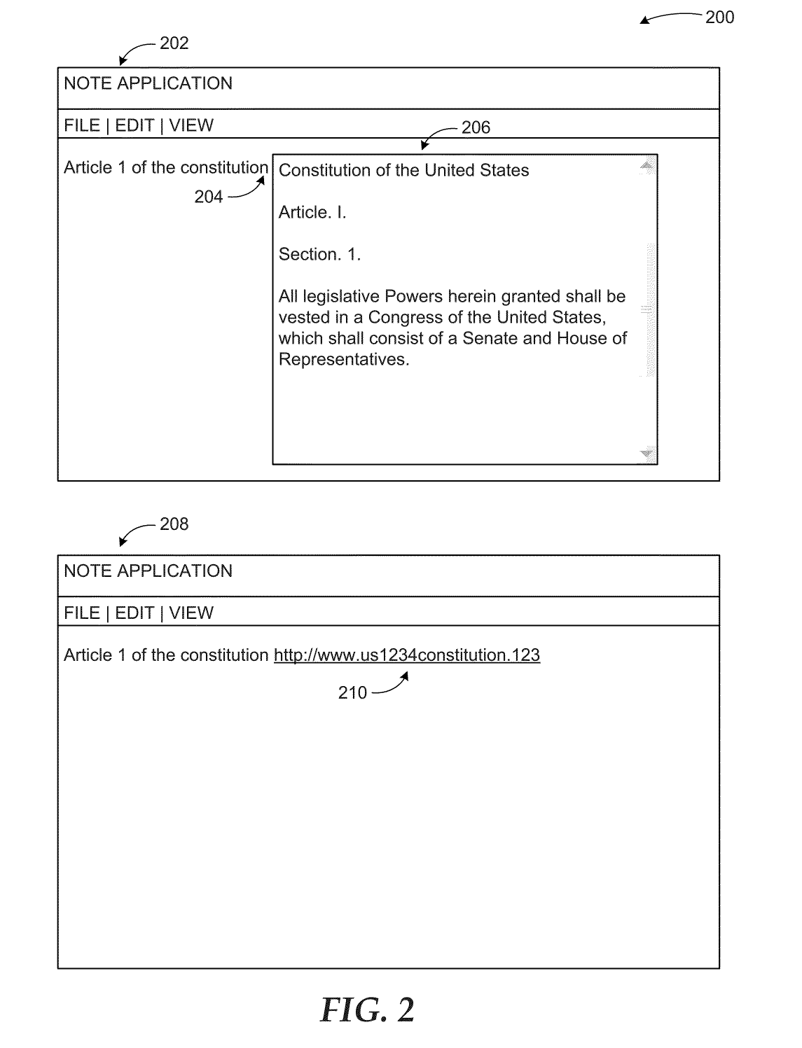

FIG. 2 is an example user interface illustrating an inline and a context aware query box within a note application, according to embodiments. Diagram 200 displays a note application 202 as a client application providing document editing functionality to users.

A query box application may listen for an interaction to activate the query box 206. The interaction may be with a part of the content displayed with the note application 202. The part of the content may be text 204. The interaction with the text 204 may include a keyboard stroke, a selection of the text 204, a highlighting of the text 204, and similar ones. The query box application may configure the query box 206 based on a context of the text 204.

Local and external sources may be searched using the text 204 to locate information associated with the text 204. The query box may be configured with a preview of the resulting data. The query box may be rendered in proximity to a location associated with a cursor position or a placement of a mouse pointer. The query box may be displayed as a part of the note application 202. The query box may be displayed within boundaries of a pane of the note application 202.

In response to detecting another action such as a selection of the query box or content displayed by the query box, the query box application may insert a hyperlink into the content displayed by the note application 208. The hyperlink may be inserted to a location in proximity to a position of the cursor or a placement of the mouse pointer. Alternatively the resulting data in the query box 206 may be allowed to be inserted into the content displayed by the note application through a copy operation on the resulting data and paste operation within the content.

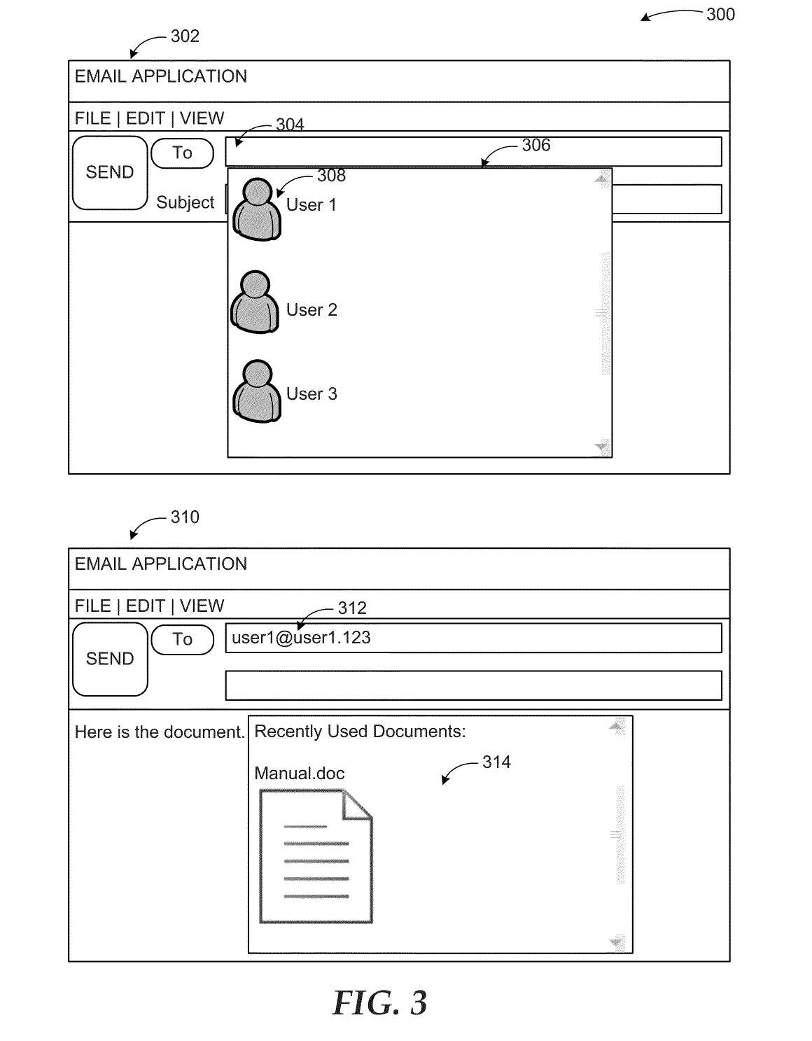

FIG. 3 is another example user interface illustrating an inline and a context aware query box within an email application, according to embodiments.

As shown in the diagram 300, a query box application may listen to detect an interaction on the email application 302 as a client application. The query box application may render the query box 306 in response to detecting the interaction. The interaction may be based on a context associated with the interaction. In an example scenario, the query box application may detect a selection of a control of the email application such as a text box 304 associated with the “To” field of the email application 302 as the interaction.

In response to the interaction, the query box application may configure the query box based on a context associated with the interaction. The query box application may search local or external contact data stores associated with the email application 302 to determine contacts to insert into the text box 304. The contacts may be sorted based on a recentness of use or a frequency of use. The query box may be rendered with the sorted contacts 308.

The sorted contacts 308 may be rendered as actionable items. In response to detecting a selection of one of the sorted contacts 308, the query box application may insert an email address associated with the selected contact into the text box 312 of the “To” field of the email application 310.

According to some embodiments, the query box application may render a query box 314 in proximity to a text of the content displayed by the email application 310. The query box application may detect an interaction with the text of the content, configure the query box based on a context of the text, and render the query box on the email application 310. In an example scenario, the text may indicate a context associated with a document. The query box application may conduct a search for the document based on actions of an author with the email application 310 or other applications utilized by the author. The query box application may present an actionable preview of one or more documents in the query box 314 to allow the author to select the one or more documents for attachment into the content of the email application 310. The content of the email application may be an email message.

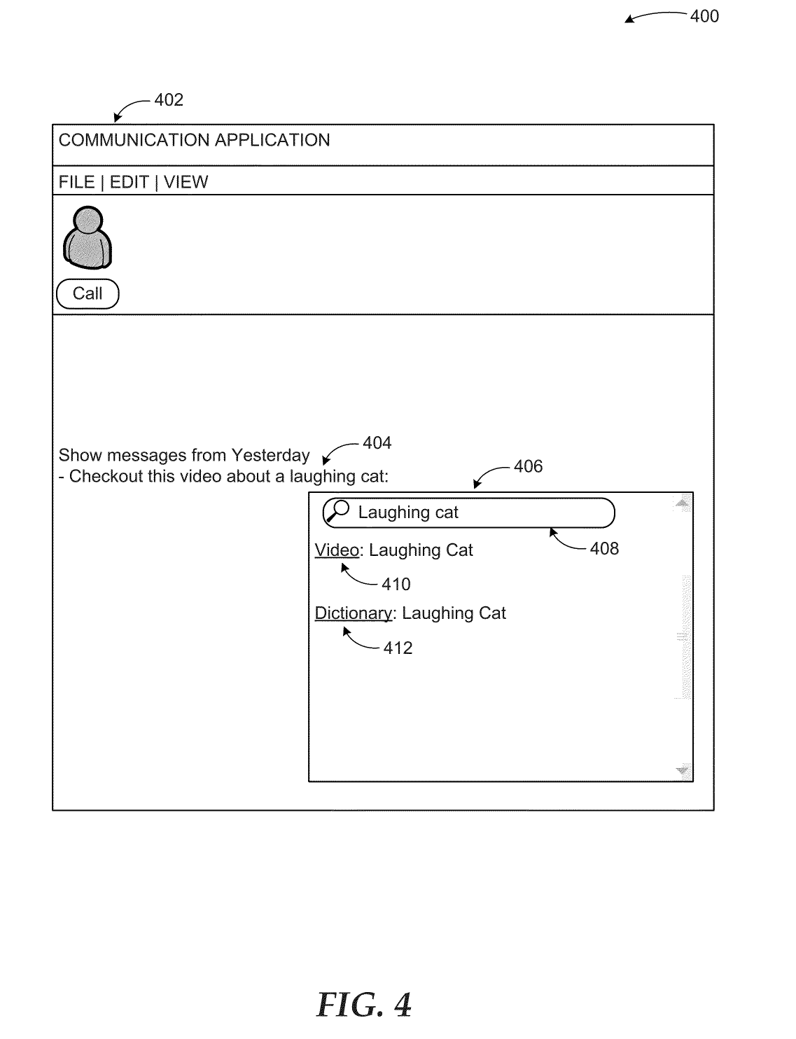

FIG. 4 is another example user interface illustrating an inline and a context aware query box within a communication application 402 as a client application.

As shown in diagram 400, a query box application may listen to detect an interaction on a communication application 402. The query box application may detect an interaction including one or more key strokes, a mouse click event, a highlighting, a selection, and similar ones associated with a text 404 of a part of a content displayed by the communication application 402. The query box application may determine a context associated with the text 404 and the interaction. The query box 406 may be configured based on the context to conduct a search associated with the text 404. The configured query box may be rendered on the communication application 402 in proximity to a location associated with the interaction. The location associated with the interaction may be adjacent to the text 404 of the content.

The text 404 may be rendered within a search box 408 to allow a user to conduct a search associated with the text 404. The query box application may search local and external sources to find content associated with the text 404. In an example scenario, the query box application may limit the search to a type of content specified by the context of the text 404.

The query box application may display a hyperlink 410 and a hyperlink 412 referencing resulting data matching the search. The resulting data may be sorted based on relevance associated with the search. Alternatively, the query box may be enabled to render the resulting data associated with the hyperlink 410 and the hyperlink 412. The query box may be enabled to display a video file, an audio file, a document, a spreadsheet, and similar ones. In response to detecting a selection of the hyperlink 410 or the hyperlink 412, the query box application may launch an application capable of rendering the resulting data associated with the hyperlink 410 or the hyperlink 412 to render the resulting data.

In addition, the resulting data searched by the query box application may be rendered in a rich format within the query box 406 using a formatting language such as hypertext markup language (HTML).

Furthermore, the query box application may determine context associated with the content based on a pane of the client application in which the query box is activated.

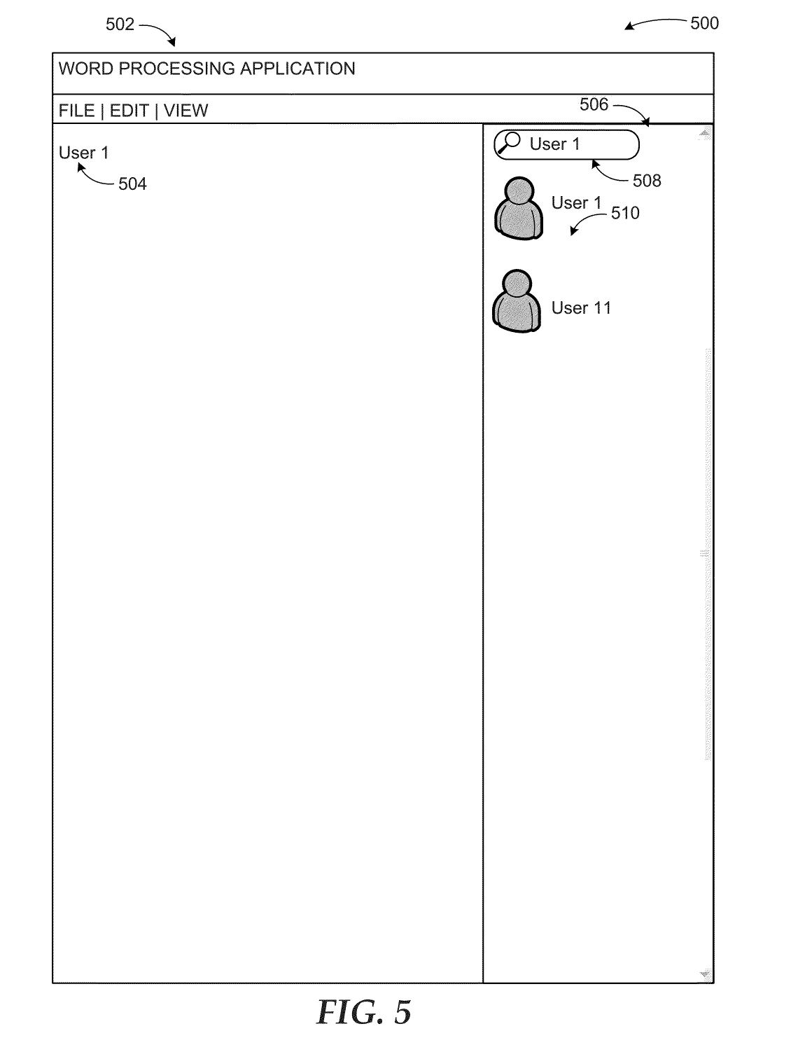

FIG. 5 is another example user interface illustrating an inline and a context aware query box as a component of a client application.

As shown in diagram 500, a query box application may render a query box 506 as a component of the word-processing application 502 as the client application. The query box may be located in a predefined region of a pane of the word processing application 502. The query box may be unmovable. The query box application may listen for an interaction with content such as text 504 to activate the query box 506. The text 504 may be inserted into a search box 508 of the query box. The query box application may initiate a search with the text 504 automatically or wait for a user action to initiate the search manually. A resulting data 510 matching a search of the text 504 may be rendered in the query box 506. The resulting data 510 may be rendered as actionable items to allow an insertion of the resulting data into the content of the word processing application 502. The resulting data (in part or wholly) may be inserted into the content in response to detecting a selection of one of the actionable items.

According to some embodiments, the query box 506 may be provided to client applications as an application programming interface (API). The API may enable a client application to render the query box as a component of the client application's code base therefore removing a need to execute a query box application to render the query box.

The example scenarios and schemas in FIGS. 2 and 5 are shown with specific components, data types, and configurations. Embodiments are not limited to systems according to these example configurations. Providing an inline and a context aware query box may be implemented in configurations employing fewer or additional components in applications and user interfaces. Furthermore, the example schema and components shown in FIGS. 2 and 5 and their subcomponents may be implemented in a similar manner with other values using the principles described herein.

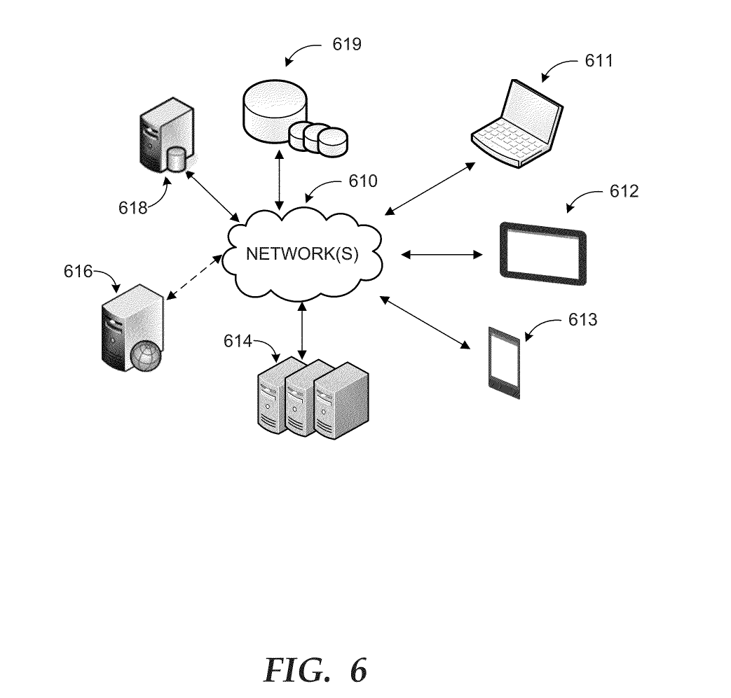

FIG. 6 is an example networked environment, where embodiments may be implemented. A system utilizing social signals to generate relationships and promote content may be implemented via software executed over one or more servers 614 such as a hosted service. The platform may communicate with client applications on individual computing devices such as a smart phone 613, a laptop computer 612, or desktop computer 611 (′client devices′) through network(s) 610.

Client applications executed on any of the client devices 611-613 may facilitate communications via application(s) executed by servers 614, or on individual server 616. A query box application may render an inline and a context aware query box within a pane of a client application. The query box may be configured based on a context associated with a content of the client application. The content of the client application and resulting data searched by the query box application may be stored in data store(s) 619 directly or through database server 618.

Network(s) 610 may comprise any topology of servers, clients, Internet service providers, and communication media. A system according to embodiments may have a static or dynamic topology. Network(s) 610 may include secure networks such as an enterprise network, an unsecure network such as a wireless open network, or the Internet. Network(s) 610 may also coordinate communication over other networks such as Public Switched Telephone Network (PSTN) or cellular networks. Furthermore, network(s) 610 may include short range wireless networks such as Bluetooth or similar ones. Network(s) 610 provide communication between the nodes described herein. By way of example, and not limitation, network(s) 610 may include wireless media such as acoustic, RF, infrared and other wireless media.

Many other configurations of computing devices, applications, data sources, and data distribution systems may be employed to provide an inline and a context aware query box. Furthermore, the networked environments discussed in FIG. 6 are for illustration purposes only. Embodiments are not limited to the example applications, modules, or processes.

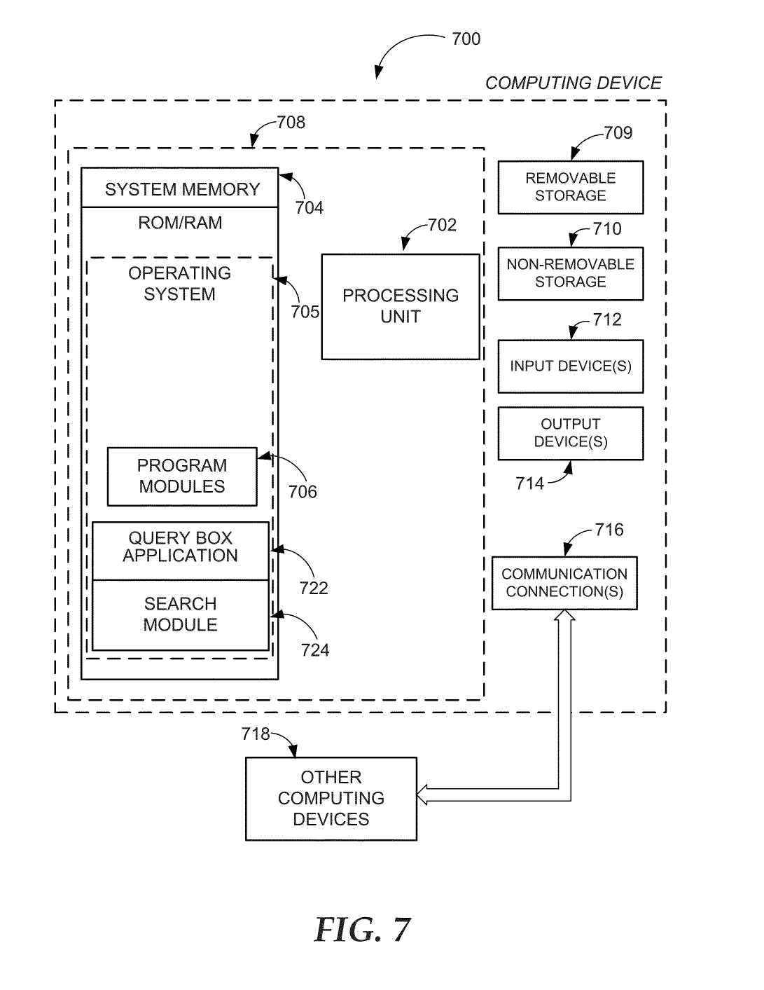

FIG. 7 and the associated discussion are intended to provide a brief, general description of a suitable computing environment in which embodiments may be implemented. With reference to FIG. 7, a block diagram of an example computing operating environment for an application according to embodiments is illustrated, such as computing device 700. In a basic configuration, computing device 700 may be any computing device executing a query box application according to embodiments and include at least one processing unit 702 and system memory 704. Computing device 700 may also include a plurality of processing units that cooperate in executing programs. Depending on the exact configuration and type of computing device, the system memory 704 may be volatile (such as RAM), non-volatile (such as ROM, flash memory, etc.) or some combination of the two. System memory 704 typically includes an operating system 705 suitable for controlling the operation of the platform, such as the WINDOWS® operating systems from MICROSOFT CORPORATION of Redmond, Wash. The system memory 704 may also include one or more software applications such as program modules 706, a query box application 722, and a search module 724.

The query box application 722 may listen to detect an interaction with content of a client application, in which the interaction is interpreted to activate a query box. The query box application 722 may configure the query box based on a context associated with the content. The search module 724 may be used to search local and external sources with the content or part of the content, associated with the interaction. The query box application 722 may render the query box in proximity to a location associated with the interaction. This basic configuration is illustrated in FIG. 7 by those components within dashed line 708.

Computing device 700 may have additional features or functionality. For example, the computing device 700 may also include additional data storage devices (removable and/or non-removable) such as, for example, magnetic disks, optical disks, or tape. Such additional storage is illustrated in FIG. 7 by removable storage 709 and non-removable storage 710. Computer readable storage media may include volatile and nonvolatile, removable and non-removable media implemented in any method or technology for storage of information, such as computer readable instructions, data structures, program modules, or other data. System memory 704, removable storage 709 and non-removable storage 710 are all examples of computer readable storage media. Computer readable storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and which can be accessed by computing device 700. Any such computer readable storage media may be part of computing device 700. Computing device 700 may also have input device(s) 712 such as keyboard, mouse, pen, voice input device, touch input device, an optical capture device for detecting gestures, and comparable input devices. Output device(s) 714 such as a display, speakers, printer, and other types of output devices may also be included. These devices are well known in the art and need not be discussed at length here.

Computing device 700 may also contain communication connections 716 that allow the device to communicate with other devices 718, such as over a wired or wireless network in a distributed computing environment, a satellite link, a cellular link, a short range network, and comparable mechanisms. Other devices 718 may include computer device(s) that execute communication applications, web servers, and comparable devices. Communication connection(s) 716 is one example of communication media. Communication media can include therein computer readable instructions, data structures, program modules, or other data. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

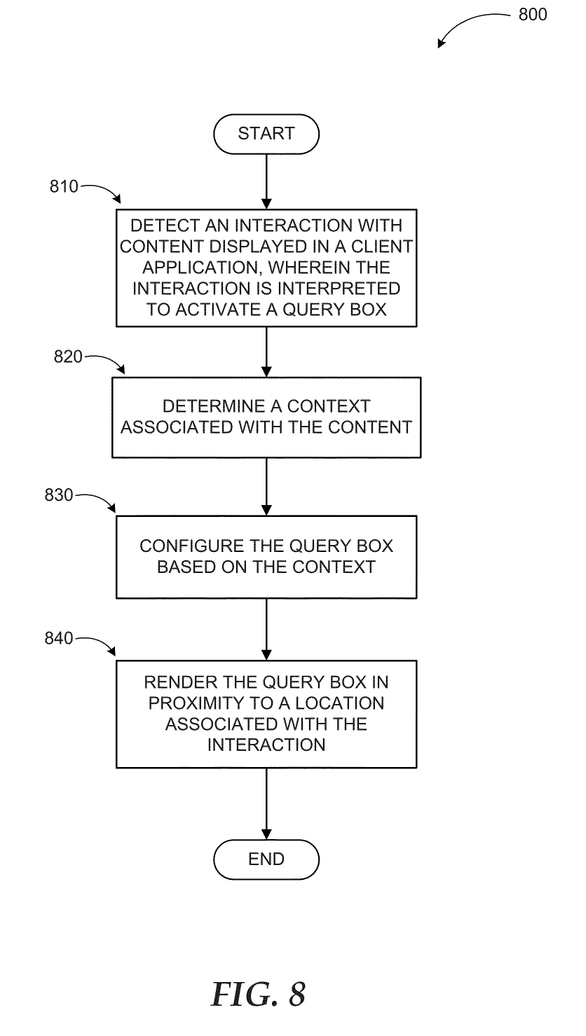

FIG. 8 illustrates a logic flow diagram for a process to provide an inline and a context aware query box according to embodiments. Process 800 may be implemented through a query box application.

Process 800 begins with operation 810 detecting an interaction with content displayed in a client application, in which the interaction is interpreted to activate a query box. The interaction may include one or more keystrokes, a mouse click event, a selection of a text of the content, a highlighting of the text of the content, and similar ones. A context associated with the content may be determined at operation 820. The context for part of the content such as a text may be determined. At operation 830, the query box may be configured based on the context. Search sources may be selected based on the context. The query box may be rendered in proximity to a location associated with the interaction at operation 840.

According to some embodiments, a method may be presented to provide an inline and a context aware query box. The method includes detecting an interaction with content displayed in a client application, wherein the interaction is interpreted to activate a query box, determining a context associated with the content, configuring the query box based on the context, and rendering the query box in proximity to a location associated with the interaction.

According to other embodiments, the method may include detecting one or more from a set of: one or more keystrokes, a mouse click event, a selection, and a highlighting associated with a text of a part of the content as the interaction. The location may be determined to include a placement of a cursor or a placement of a mouse pointer within the client application. The query box may be displayed within boundaries of a pane of the client application. One or more of an external source and a local source may be searched using a text of a part of the content associated with the interaction to locate resulting data. The resulting data may be sorted based on one or more of a frequency of use and a recentness of use associated with the resulting data and a preview of the resulting data may be displayed in the query box.

According to yet other embodiments, an actionable preview of resulting data may be presented within the query box in response to conducting a search based on a text of a part of the content associated with the interaction and a selection of the resulting data may be detected through an actionable preview. The resulting data may be inserted into the content displayed in the client application. The resulting data may be placed adjacent to the text. A hyperlink referencing the resulting data may be inserted into the content displayed in the client application, in which the resulting data is stored by an external source. The hyperlink may be placed adjacent to the text.

According to some embodiments, a computing device (700) may be presented to provide an inline and a context aware query box. The computing device may include a memory, a processor coupled to the memory. The processor may execute a query box application in conjunction with instructions stored in the memory. The query box application is configured to detect an interaction with content displayed in a client application, wherein the interaction is interpreted to activate a query box, determine a context associated with the content, search at least one of an external source and a local source using a text of a part of the content associated with the interaction to locate resulting data, configure the query box based on the context and while using the resulting data, and render the query box in proximity to a location associated with the interaction.

According to other embodiments, the query box application is further configured to render the resulting data within the query box in a rich format using a formatting language including hypertext markup language (HTML). The context may be determined based on a pane of the client application in which the query box is activated. An insertion of the resulting data may be allowed into the content through a copy operation on the resulting data that is followed by a paste operation within the content. The context may be determined based on the interaction. A selection of a control of the client application may be detected to determine the context.

According to some embodiments, a computer-readable memory device may be presented to provide an inline and a context aware query box. The instructions may include detecting an interaction with content displayed in a client application, wherein the interaction is interpreted to activate a query box, determining a context associated with the content, searching at least one of an external source and a local source using a text of a part of the content associated with the interaction to locate resulting data, configuring the query box based on the context while using the resulting data, and rendering the query box as a component of the client application.

According to other embodiments, the instructions may further include providing the query box as an application programming interface (API) to the client application to allow the client application to render the query box. The resulting data may be rendered as actionable items to allow an insertion of the resulting data into the content.

The operations included in process 800 are for illustration purposes. A query box application may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed on a computing device to provide an inline and a context aware query box, the method comprising:
detecting an interaction with content displayed by a client application, wherein the interaction is interpreted to activate a query box;
determining a context associated with the content;
configuring the query box based on the context; and
rendering the query box in proximity to a location associated with the interaction.

2. The method of claim 1, further comprising:
detecting one or more from a set of: one or more keystrokes, a mouse click event, a selection, and a highlighting associated with a text of a part of the content as the interaction.

3. The method of claim 1, further comprising:
determining the location to include a placement of a cursor or a placement of a mouse pointer within a user interface of the client application.

4. The method of claim 1, further comprising:
displaying the query box within boundaries of a pane of the user interface of the client application.

5. The method of claim 1, further comprising:
searching at least one of an external source and a local source using a text of a part of the content associated with the interaction to locate resulting data.

6. The method of claim 5, further comprising:
sorting the resulting data based on at least one of a frequency of use and a recentness of use associated with the resulting data; and
displaying a preview of the resulting data in the query box.

7. The method of claim 1, further comprising:
presenting an actionable preview of resulting data within the query box in response to conducting a search based on a text of a part of the content associated with the interaction; and
detecting a selection of the resulting data through an actionable preview.

8. The method of claim 7, further comprising:
inserting the resulting data into the content displayed by the client application.

9. The method of claim 8, further comprising:
placing the resulting data adjacent to the text.

10. The method of claim 7, further comprising:
inserting a hyperlink referencing the resulting data into the content displayed by the client application, wherein the resulting data is stored by an external source.

11. The method of claim 10, further comprising:
placing the hyperlink adjacent to the text.

12. A computing device to provide an inline and a context aware query box, the computing device comprising:
a memory;
a processor coupled to the memory, the processor executing a query box application in conjunction with instructions stored in the memory, wherein the query box application is configured to:
detect an interaction with content displayed by a client application, wherein the interaction is interpreted to activate a query box;
determine a context associated with the content;
search at least one of an external source and a local source using a text of a part of the content associated with the interaction to locate resulting data;
configure the query box based on the context and while using the resulting data; and
render the query box in proximity to a location associated with the interaction.

13. The computing device of claim 12, wherein the query box application is further configured to:
render the resulting data within the query box in a rich format using a formatting language including hypertext markup language (HTML).

14. The computing device of claim 12, wherein the query box application is further configured to:
determine the context based on a pane of a user interface of the client application in which the query box is activated.

15. The computing device of claim 12, wherein the query box application is further configured to:
allow an insertion of the resulting data into the content through a copy operation on the resulting data that is followed by a paste operation within the content.

16. The computing device of claim 12, wherein the query box application is further configured to:
determine the context based on the interaction.

17. The computing device of claim 16, wherein the query box application is further configured to:
detect a selection of a control of a user interface of the client application to determine the context.

18. A computer-readable memory device with instructions stored thereon to provide an inline and a context aware query box, the instructions comprising:
detecting an interaction with content displayed by a client application, wherein the interaction is interpreted to activate a query box;
determining a context associated with the content;
searching at least one of an external source and a local source using a text of a part of the content associated with the interaction to locate resulting data;
configuring the query box based on the context while using the resulting data; and
rendering the query box as a component of a user interface of the client application.

19. The computer-readable memory device of claim 18, wherein the instructions further comprise:
providing the query box as an application programming interface (API) to the client application to allow the client application to render the query box.

20. The computer-readable memory device of claim 18, wherein the instructions further comprise:
rendering the resulting data as actionable items to allow an insertion of the resulting data into the content.
